(19) United States
(12) Patent Application Publication
(10) Pub. No.: US 2012/0072078 A1
(43) Pub. Date: Mar. 22, 2012

(54) COLLISION DETERMINING APPARATUS FOR VEHICLE

(75) Inventor: Tatsuji Oosaki, Utsunomiya-shi (JP)

(73) Assignee: KEIHIN CORPORATION, Tokyo (JP)

(21) Appl. No.: 13/222,307

(22) Filed: Aug. 31, 2011

(30) Foreign Application Priority Data
Sep. 17, 2010 (JP) 2010-209505

(51) Int. Cl. B60R 21/013

(52) U.S. Cl. 701/46; 701/47

(57) ABSTRACT

A collision determining apparatus for a vehicle includes a vibration detection device that detects a high-frequency vibration of an audio band generated in a vehicle and a low-frequency vibration of the audio band which is lower than the high-frequency vibration; and a collision determining device that determines whether or not a collision requiring an activation of an occupant protection apparatus of the vehicle has occurred based on the detection result of the high-frequency vibration and the low-frequency vibration.

Priority is claimed on Japanese Patent Application No. 2010-209505, filed Sep. 17, 2010, the disclosure of which is hereby incorporated herein by reference in its entirety.

### BACKGROUND

1. Field of the Invention

The present invention relates to a collision determining apparatus for a vehicle.

2. Description of Related Art

Generally, as system for protecting occupant at a time of a vehicle collision, SRS(Supplemental Restraint System) airbag system is known. This SRS airbag system is a system that detects an occurrence of a vehicle collision and activates an occupant protection apparatus such as airbag based on an acceleration data obtained from an acceleration sensor provided in each section of a vehicle.

Previously, the technologies are known that determinates whether or not a frontal collision (including a nose-to-nose collision, an offset collision, a diagonal collision) has occurred based on acceleration data obtained from a plurality of front crash sensors provided in a front section of the vehicle and an unit sensor in a SRS unit (an ECU that overall controls the SRS airbag system) provided in center section of the vehicle and controls an activation of the occupant protection apparatus depending to the collision determining result (e.g., Japanese Unexamined Patent Application, First Publication No. H10-287203).

Moreover, recently, the development of CISS (Crash Impact Sound Sensing) technology is advanced that detects an impact sound generated by a vehicle deformation at a time of a collision by using a structural sound sensing accelerometer and performs a collision determining based on the detection result. Published Japanese Translation No. 2001-519268 of the PCT International Publication discloses a technology that detects a deflection of a bulk sound wave in transversal direction generated in vehicle body components (side member) at a time of a vehicle collision by using a bulk sound wave sensor and performs a collision determining based on the detection result.

As described in Japanese Unexamined Patent Application, First Publication No. H10-287203, the front crash sensor and the unit sensor are needed to perform foreside collision determining by using the acceleration sensor, because there are collision modes (a high-speed offset collision requiring the activation of occupant protection apparatus and a low-speed offset collision not requiring the activation of occupant protection apparatus) which are difficult to be determined by using only the unit sensor. Since the unit sensor is provided in a center section of the vehicle where the vehicle deformation at the time of the frontal collision is petty, it is needed for long time (about 40 ms or more) until the sensor output indicates a significant difference which can be accurately distinguished from both of the collision mode from the time point of the collision occurrence.

Namely, in a case of using only the unit sensor, a threshold value setting is needed to execute collision determining (specifically, threshold value determining) after 40 ms from the time point of the collision occurrence, thus the activation timing of occupant protection apparatus inevitably delays. From a viewpoint of an occupant protection, in using only the unit sensor, it is not possible to satisfy the required performance of the occupant protection since it is said that the activation of the occupant protection apparatus should be ideally performed in a time between 20 ms and 30 ms from the time point of the collision occurrence. So, previously, it is possible to achieve rapid and accurate collision determining by providing the front crash sensor in a front section of the vehicle where the vehicle deformation at the time of the frontal collision is extensive.

Since the front crash sensor is a factor for leading system cost up, it is ideal to perform the collision determining by using only the unit sensor built-in the SRS unit, but as described above, in using only the unit sensor, it is not possible to satisfy the required performance of the occupant protection. So, a system without the front crash sensor is tested for configuration using the structural sound sensing accelerometer as the unit sensor instead of the acceleration sensor. A structural sound sensing accelerometer data obtained from the structural sound sensing accelerometer has a tendency to easily capture the feature where a vehicle body deforms (destroys), and facility to distinguish a high-speed offset collision from a low-speed offset collision, thus it is effective for achievement of rapid and accurate collision determination.

However, since the structural sound sensing accelerometer data obtained from the structural sound sensing accelerometer includes a lot of a local hitting sound caused by flying rocks and so on without the vehicle deformation, it is needed to accurately distinguish an impact sound caused by a collision requiring the activation of the occupant protection apparatus and a local hitting sound not requiring the activation of the occupant protection apparatus. Therefore, it is a problem for developing a technology to accurately distinguish an impact sound caused by a collision and a local hitting sound caused by flying rocks and so on to be compatible with maintenance of the required performance of the occupant protection and cost reduction.

An object of the present invention is to provide a collision determining apparatus for a vehicle that is compatible with maintenance of performance of the occupant protection and cost reduction.

### SUMMARY

(1) An aspect of the present invention includes a vibration detection device that detects a high-frequency vibration of an audio band generated in a vehicle and a low-frequency vibration of the audio band which is lower than the high-frequency vibration; and a collision determining device that determines whether or not a collision requiring an activation of an occupant protection apparatus of the vehicle has occurred based on the detection result of the high-frequency vibration and the low-frequency vibration.
(2) In the aspect as (1) described above, the vibration detection device may include a first vibration sensor that detects a frequency band from 5 kHz to 20 kHz as the high-frequency vibration of the audio band; and a second vibration sensor that detects a frequency band from 0 Hz to 500 Hz as the low-frequency vibration of the audio band which is lower than the high-frequency vibration.
(3) In the aspect as (2) described above, both of the first vibration sensor and the second vibration sensor may be built in a sensor cell.
(4) An aspect of the present invention includes a vibration detection device that detects a broad-band vibration generated in a vehicle; a first extraction device that extracts a high-frequency vibration of an audio band from the broad-band vibration detected by the vibration detection device; a second extraction device that extracts a low-frequency vibration of the audio band which is lower than the high-frequency vibration from the broad-band vibration detected by the vibration detection device; and a collision determining device that determines whether or not a collision requiring an activation of an occupant protection apparatus of the vehicle has occurred based on the detection result of the high-frequency vibration and the low-frequency vibration.
(5) The aspect as (4) described above may adopt a configuration in which: the first extraction device extracts the frequency band from 5 kHz to 20 kHz from the broad-band vibration, as the high-frequency vibration of the audio band and the second extraction device extracts the frequency band from 0 Hz to 500 Hz from the broad-band vibration as the low-frequency vibration of the audio band which is lower than the high-frequency vibration.
(6) In the aspect as (1) or (4) described above, the collision determining device may include a first calculation device that calculates a first calculation value based on the detection result of the high-frequency vibration; a second calculation device that calculates a second calculation value based on the detection result of the low-frequency vibration; and a map determining device that determines that a collision requiring the activation of the occupant protection apparatus has occurred, when, in a two-dimension map where a first axis is the first calculation value and a second axis is the second calculation value, the first calculation value and the second calculation value calculated by the first calculation device and the second calculation device exceed a two-dimension collision determining threshold value set in two-dimensions.
(7) In the aspect as (1) or (4) described above, the collision determining device may include a first calculation device that calculates a first calculation value based on the detection result of the high-frequency vibration; a second calculation device that calculates a second calculation value based on the detection result of the low-frequency vibration; and a threshold value determining device that determines that a collision requiring the activation of the occupant protection apparatus has occurred when the first calculation value exceeds a first collision determining threshold value and the second calculation value exceeds a second collision determining threshold value.
(8) The aspect as (1) or (4) described above may further include a safing determining device that performs a safing determining based on the detection result of the low-frequency vibration; and a final determining device that finally determines whether or not a collision requiring the activation of the occupant protection apparatus has occurred based on the collision determining result of the collision determining device and the safing determining result of the safing determining device.

According to the above-mentioned aspects of the present invention, it is possible to rapidly and accurately distinguish without using the front crash sensor as previous, the collision requiring the activation of the occupant protection apparatus (a violent collision with vehicle deformation including the high-speed offset collision) from the collision not requiring the activation of the occupant protection apparatus (a soft collision with petty vehicle deformation including the low-speed offset collision and local hitting by flying rocks and so on). Namely, according to the present invention, it is possible to provide a collision determining apparatus for a vehicle that is compatible with maintenance of performance of the occupant protection equal to or more than of the traditional technology and total system cost reduction.

### BRIEF DESCRIPTION OF THE DRAWINGS

FIG. 1A is main block configuration diagram of SRS airbag system in first embodiment of the present invention.

FIG. 1B is main block configuration diagram of SRS unit 1 (collision determining apparatus for a vehicle) in first embodiment of the present invention.

FIG. 2A is a diagram that shows a two-dimension map using for a collision determining.

FIG. 2B is a diagram that shows a change in time of structural sound sensing accelerometer data S(t) obtained from structural sound sensing accelerometer 11 at a time of a high-speed offset collision and at a time of a low-speed offset collision.

FIG. 3 is main block configuration diagram of SRS unit 1A (collision determining apparatus for a vehicle) in second embodiment.

FIG. 4 is main block configuration diagram of SRS unit 1B (collision determining apparatus for a vehicle) in third embodiment.

### DESCRIPTION OF THE EMBODIMENTS

Hereinbelow, the embodiments of the present invention will be explained, referencing the drawings.

### First Embodiment

Firstly, a first embodiment according to the present invention will be explained.

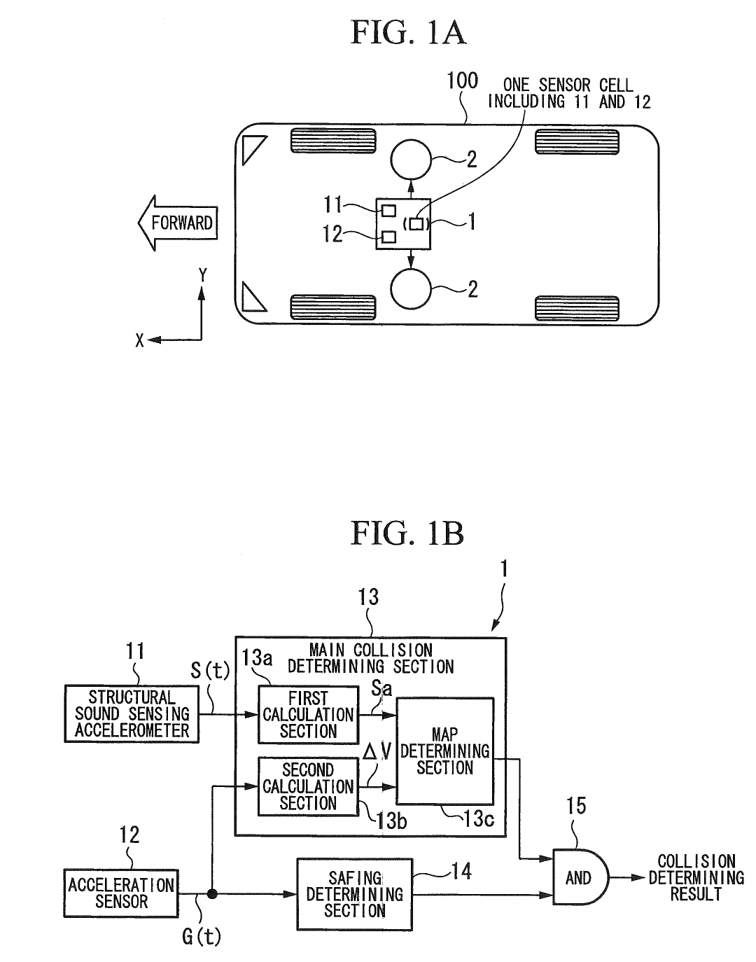

FIG. 1A is schematic diagrams of configuration of a SRS airbag system in the present embodiment. As shown in FIG. 1A, the SRS airbag system in the present embodiment includes a SRS unit 1 (a collision determining apparatus for a vehicle) provided in a center section of a vehicle 100 and an airbag 2 (an occupant protection apparatus) provided in a driver's seat and a front passenger seat of the vehicle 100.

The SRS unit 1 is an ECU (Electronic Control Unit) that performs determining (a collision determining) whether or not a frontal collision in the vehicle 100 has occurred based on an output signal of a structural sound sensing accelerometer 11 and an acceleration sensor 12 built therein and performs an activation control of the airbag 2 depending to the collision determining result. The airbag 2 is an occupant protection apparatus that expands depending to an ignition signal input from the SRS unit 1 to reduce injury when an occupant secondary crash forward by the frontal collision of the vehicle 100. Generally, other occupant protection apparatuses such as a seatbelt pretensioner other than the airbag 2 are also provided in the vehicle 100, however, these are omitted in FIG. 1A.

FIG. 1B is main block configuration diagram of the SRS unit 1. As shown in FIG. 1B, the SRS unit 1 includes a structural sound sensing accelerometer 11 (a first vibration sensor), an acceleration sensor 12 (a second vibration sensor), a main collision determining section 13 (a collision determining device), a safing determining section 14 (a safing determining device), and an AND section 15 (a final determining device).

The structural sound sensing accelerometer 11 is a vibration sensor built in the SRS unit 1 that detects a high-frequency vibration of an audio band generated in a longitudinal direction of the vehicle 100 (X axis direction in FIG. 1A) and outputs the detection result as structural sound sensing accelerometer data S(t) to the main collision determining section 13. Specifically, this structural sound sensing accelerometer 11 detects vibration (structure audio) in a frequency band from 5 kHz to 20 kHz as the high-frequency vibration of the audio band. Structural sound sensing accelerometer data S(t) obtained from this structural sound sensing accelerometer 11 preferably captures the feature where the vehicle 100 deforms (destroys) by the frontal collision.

The acceleration sensor 12 is a vibration sensor built in the SRS unit 1 that detects a low-frequency vibration of the audio band which is lower than the high-frequency vibration generated in the longitudinal direction of the vehicle 100 and outputs the detection result as acceleration data G(t) to the main collision determining section 13 and the safing determining section 14. Specifically, this acceleration sensor 12 detects vibration in a frequency band from 0 Hz to 500 Hz as the low-frequency vibration of the audio band which is lower than the high-frequency vibration. Acceleration data G(t) obtained from this acceleration sensor 12 preferably captures the deceleration generated in the vehicle 100 by the frontal collision.

Thus, a difference between the structural sound sensing accelerometer 11 and the acceleration sensor 12 is only a difference between the frequency bands in a detection target vibration and both of them belong to the vibration sensors. The structural sound sensing accelerometer 11 and the acceleration sensor 12 configure a vibration detection device in the present invention. As shown in FIG. 1A, in the SRS unit 1, each of the structural sound sensing accelerometer 11 and the acceleration sensor 12 may be individually provided therein, or the structural sound sensing accelerometer 11 the acceleration sensor 12 may be built in a sensor cell.

The main collision determining section 13 determines whether or not a collision requiring an expansion (an activation) of the airbag 2 has occurred based on the structural sound sensing accelerometer 11 input from structural sound sensing accelerometer data S(t) and the acceleration sensor 12 input from acceleration data G(t) and includes a first calculation section 13a(a first calculation device), a second calculation section 13b (a second calculation device) and a map determining section 13c (a map determining device).

The first calculation section 13a calculates an audio average value Sa (a first calculation value) by applying an averaging processing to structural sound sensing accelerometer data S(t) input from the structural sound sensing accelerometer 11 and then outputs the calculation result to the map determining section 13c. As the averaging processing of structural sound sensing accelerometer data S(t), a movement average processing, an integrating processing, or a low-pass filtering processing and so on can be available.

The second calculation section 13b calculates an amount of change of velocity ΔV (a second calculation value) by primarily integrating acceleration data G(t) input from acceleration sensor 12 and then outputs the calculation result to map determining section 13c. It may also calculate amount of change of movement as the second calculation value by secondary integrating acceleration data G(t) instead of the amount of change of velocity ΔV.

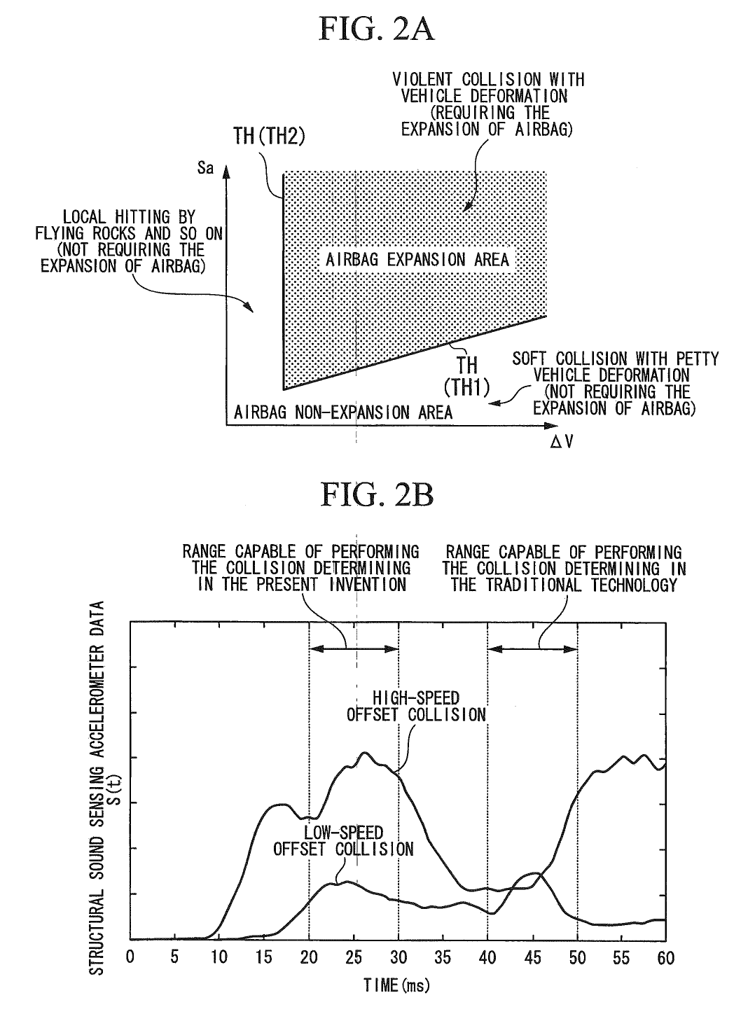

As shown in FIG. 2A, when the audio average value Sa and the amount of change of velocity ΔV calculated by the first calculation section 13a and the second calculation section 13b exceed a two-dimension collision determining threshold value TH set to be two-dimensional on a two-dimension map where the vertical axis represents the audio average value Sa and the horizontal axis represents the amount of change of velocity ΔV, the map determining section 13c determines that a collision requiring the expansion of the airbag 2 has occurred and then outputs the map determining result to the AND section 15.

The setting steps of the two-dimension collision determining threshold value TH on the two-dimension map will describe below. As described above, structural sound sensing accelerometer data S(t) obtained from the structural sound sensing accelerometer has the tendency to easily capture the feature where the vehicle body deforms (destroys) and the facility to distinguish a high-speed offset collision from a low-speed offset collision, thus it is effective for achievement of rapid and accurate collision determining. FIG. 2B shows a change in time of structural sound sensing accelerometer data S(t) obtained from the structural sound sensing accelerometer 11 at a time of the high-speed offset collision and at a time of the low-speed offset collision. As shown in FIG. 2B, when more than about 20 ms passed from a time point of a collision occurrence (time 0), a significant difference where both of collision modes can be accurately distinguished is indicated in structural sound sensing accelerometer data S(t).

Namely, in traditional (in the case of performing the collision determining with only the acceleration sensor in the SRS unit), a threshold value setting should be perform to execute a collision determining (a threshold value determining) after 40 ms (from 40 ms to 50 ms in detail) from a time point of a collision occurrence, however, by using structural sound sensing accelerometer data S(t) obtained from the structural sound sensing accelerometer 11 for the collision determining, it is possible to perform the threshold value setting to execute the collision determining after 20 ms (from 20 ms to 30 ms in detail) from the time point of the collision occurrence.

Therefore, on the two-dimension map shown in FIG. 2A, the two-dimension collision determining threshold value TH(TH1) extending in the horizontal axis direction is set to the value by which, in a time between 20 ms and 30 ms from at the time point of the collision occurrence, a collision requiring the expansion of the airbag 2 (a violent collision with a vehicle deformation (destruction) including a high-speed offset collision), a collision not requiring the expansion of the airbag 2 (a soft collision with a petty vehicle deformation including the low-speed offset collision) can be distinguished.

Since the more the amount of change of velocity ΔV increases, the more the structure audio generated in the vehicle 100 increases, if the two-dimension collision determining threshold value TH(TH1) extending in the horizontal axis direction is a constant value, although the collision not requiring the expansion of the airbag 2 essentially has occurred, it is likely to erroneously determine that the collision requiring the expansion of the airbag 2 has occurred. So, to prevent the foregoing erroneous determination, as shown in FIG. 2A, the two-dimension collision determining threshold value TH(TH1) extending in the horizontal axis direction is preferably set to a higher value with an increasing amount of change of velocity ΔV.

Meanwhile, since structural sound sensing accelerometer data S(t) obtained from structural sound sensing accelerometer 11 includes a lot of a local hitting sound caused by flying rocks and so on without the vehicle deformation, it is necessary to accurately distinguish between an impact sound caused by a collision requiring the expansion of the airbag 2 and a local hitting sound not requiring the expansion of the airbag 2 Acceleration data G(t) obtained from the acceleration sensor 12 may be used to distinguish between an impact sound caused by a collision and a local hitting sound caused by flying rocks and so on as described above. When an impact sound is caused by a collision, a significant deceleration is generated, on the other hand, when a local hitting sound is caused by, for example, flying rocks, only a small amount of deceleration is generated.

Namely, on the two-dimension map shown in FIG. 2A, the two-dimension collision determining threshold value TH(TH2) extending in the vertical axis direction is set to a value by which, a distinction can be made a collision requiring the expansion of the airbag 2 (the violent collision with vehicle deformation) and a collision not requiring the expansion of the airbag 2 (the local hitting by flying rocks and so on). Since the deceleration does not significantly change even if the local hitting sound caused by flying rocks and so on increases, the two-dimension collision determining threshold value TH(TH2) extending in the vertical axis direction may be set to constant value with respect to the audio average value Sa.

By setting the two-dimension collision determining threshold value TH on the two-dimension map in the above-mentioned step, an airbag expansion area where the expansion of the airbag 2 performs and an airbag non-expansion area where the expansion of the airbag 2 does not perform are formed on the two-dimension map. Namely, the map determining section 13c determines that the collision requiring the expansion of the airbag 2 has occurred, in a case that the audio average value Sa calculated in the first calculation section 13a exceeds the two-dimension collision determining threshold value TH(TH1) and the amount of change of velocity ΔV calculated in the second calculation section 13b exceeds the two-dimension collision determining threshold value TH(TH2) (in other words, in a case where a cross point of the audio average value Sa and the amount of change of velocity ΔV is included in the airbag expansion area).

Return to FIG. 1B, the safing determining section 14 performs a safing determining based on acceleration data G(t) input from the acceleration sensor 12 and then outputs the safing determining result to the AND section 15. Specifically, this safing determining section 14 compares a primary integrated value (or a secondary integrated value) of acceleration data G(t) with a safing determining threshold value and then determines that the collision requiring the expansion of the airbag 2 has occurred when the primary integrated value is more than the safing determining threshold value. The safing determining threshold value is set to a value directed to a safe side (comparatively lower value) to surely expand the airbag 2 when a certainly significant collision (a significant deceleration) has occurred.

The AND section 15 finally determines whether or not a collision requiring the expansion of the airbag 2 has occurred based on the collision determining result (the map determining result) from the main collision determining section 13 and the safing determining result from the safing determining section 14, and then outputs the collision determining result. Specifically, the AND section 15 finally determines that the collision requiring the activation of the airbag 2 has occurred when both of the main collision determining section 13 and the safing determining section 14 determine that a collision requiring the expansion of the airbag 2 has occurred.

The SRS unit 1 configured as described above, without using the front crash sensor as previously, can rapidly and accurately distinguish between a collision requiring the expansion of the airbag 2 (the violent collision with the vehicle deformation including the high-speed offset collision) and a collision not requiring the expansion of the airbag 2 (the soft collision with little vehicle deformation including the low-speed offset collision and including the local hitting by flying rocks and so on). Namely, according to the present embodiment, it is possible to provide a SRS unit 1 that is compatible with maintenance of performance of the occupant protection equal to or more than the traditional technology, and to a total system cost reduction. Moreover, by using the two-dimension map shown in FIG. 2A for the collision determining, the threshold value setting in two-dimensions can be performed and advancement of the accuracy of collision determining (advancement of the occupant protection performance) can be provided.

### Second Embodiment

Next, a second embodiment according to the present invention will be described. Hereinbelow, the second embodiment will be discussed, and components the same those of the first embodiment will be given the same reference numbers, and a duplicate explanation thereof will be omitted here.

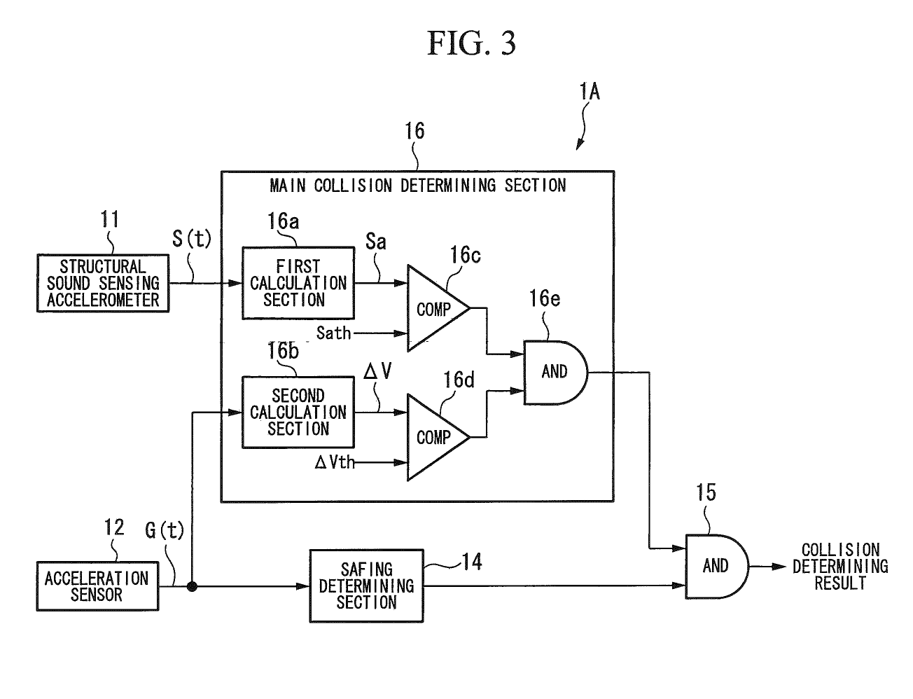

FIG. 3 is main block configuration diagram of a SRS unit 1A in the second embodiment. As shown in FIG. 3, the SRS unit 1A in the second embodiment includes a main collision determining section 16 that has a different configuration than the main collision determining section 13 in the first embodiment.

The main collision determining section 16 determines whether or not collision requiring the expansion of the airbag 2 has occurred based on structural sound sensing accelerometer data S(t) input from the structural sound sensing accelerometer 11 and acceleration data G(t) input from the acceleration sensor 12 and includes a first calculation section 16a (a first calculation device), a second calculation section 16b (a second calculation device), a first comparison section 16c, a second comparison section 16d, and an AND section 16e. Out of the above-mentioned components, the first comparison section 16c, the second comparison section 16d and the AND section 16e configure a threshold value determining device in the present invention.

The first calculation section 16a calculates the audio average value Sa (the first calculation value) by applying the averaging processing to structural sound sensing accelerometer data S(t) input from the structural sound sensing accelerometer 11 and then outputs the calculation result to the first comparison section 16c. The second calculation section 16b calculates the amount of change of velocity ΔV (the second calculation value) by primarily integrating acceleration data G(t) input from the acceleration sensor 12 and then outputs the calculation result to the second comparison section 16d.

The first comparison section 16c determines whether or not the audio average value Sa input from the first calculation section 16a exceeds a first collision determining threshold value Sath and then outputs the comparison determining result to the AND section 16e. The second comparison section 16d determines whether or not the amount of change of velocity ΔV input from the second calculation section 16b exceeds a second collision determining threshold value ΔVth and then outputs the comparison determining result to the AND section 16e. The AND section 16e determines whether or not the collision requiring the expansion of the airbag 2 has occurred when the first comparison section 16c and the second comparison section 16d determine that the audio average value Sa exceeds the first collision determining threshold value Sath and the amount of change of velocity ΔV exceeds the second collision determining threshold value ΔVth and then outputs the collision determining result to the AND section 15.

Here, the first collision determining threshold value Sath is set to the value by which, in a time between 20 ms and 30 ms from the time point of the collision occurrence, a collision requiring the expansion of the airbag 2 (a violent collision with vehicle deformation (destruction) including a high-speed offset collision) and a collision not requiring the expansion of the airbag 2 (a soft collision with little vehicle deformation including a low-speed offset collision) can be distinguished. Moreover, the second collision determining threshold value ΔVth is set to the value at which, a collision requiring the expansion of the airbag 2 (a violent collision with the vehicle deformation) and a collision not requiring the expansion of the airbag 2 (a local hitting by flying rocks and so on) can be distinguished.

The SRS unit 1A in the second embodiment configured as described above, similarly to the SRS unit 1 in the first embodiment, without using the front crash sensor as previously, can rapidly and accurately distinguish between a collision requiring expansion of the airbag 2 (a violent collision with the vehicle deformation including a high-speed offset collision) and a collision not requiring expansion of the airbag 2 (a soft collision with little vehicle deformation including the low-speed offset collision and including a local hitting by flying rocks and so on).

### Third Embodiment

Next, a third embodiment according to the present invention will be described. Hereinbelow, the third embodiment will be discussed, and components the same those of the first or second embodiment will be given the same reference numbers, and a duplicate explanation thereof will be omitted here.

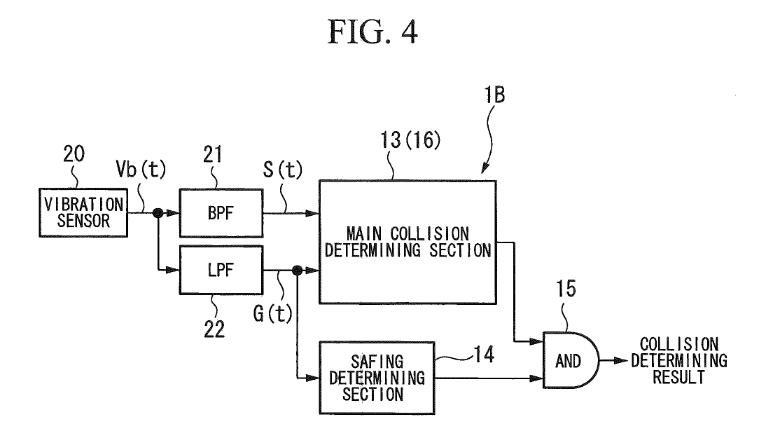

FIG. 4 is main block configuration diagram of a SRS unit 1B in the third embodiment. As shown in FIG. 4, the SRS unit 1B in the third embodiment includes a vibration sensor (a vibration detection device) 20, a BPF (a band path filter/a first extraction device) 21, a LPF (a low-pass filter/a second extraction device) 22, the main collision determining section 13 the same as in the first embodiment (or the main collision determining section 16 as same as in the second embodiment), the safing determining section 14 and the AND section 15 is the same in the first and second embodiments.

The vibration sensor 20 detects a broad-band vibration generated in the longitudinal direction of the vehicle 100 (e.g., a frequency band from 0 Hz to 30 kHz) and then outputs the detection result as vibration data Vb(t) to the BPF 21 and the LPF 22.

The BPF 21 extracts the high-frequency vibration of the audio band from vibration data Vb(t) input from the vibration sensor 20 and then outputs the extracted result (the detection result of the high-frequency vibration) as structural sound sensing accelerometer data S(t) to the main collision determining section 13. Specifically, this BPF 21 extracts a frequency band from 5 kHz to 20 kHz (a structure audio) from vibration data Vb(t) as the high-frequency vibration of the audio band.

The LPF 22 extracts the low-frequency vibration of the audio band which is lower than the high-frequency vibration from vibration data Vb(t) input from the vibration sensor 20 and then outputs the extracted result (the detection result of the low-frequency vibration) as acceleration data G(t) to the main collision determining section 13 and the safing determining section 14. Specifically, this LPF 22 extracts a frequency band from 0 Hz to 500 Hz from vibration data Vb(t) as the low-frequency vibration of the audio band which is lower than the high-frequency vibration.

As described above, in the first and second embodiments, two vibration sensors (the structural sound sensing accelerometer 11 and the acceleration sensor 12) are used. Meanwhile, in the third embodiment, only one vibration sensor 20 that can detect the broad-band vibration of the frequency band from 0 Hz to 30 kHz is provided, and vibration component of the frequency band from 0 Hz to 500 Hz extracted by the LPF 22 from the sensor outputting is used as acceleration data G(t) and vibration component of the frequency band from 5 kHz to 20 kHz extracted by the BPF 21 from the sensor outputting is used as structural sound sensing accelerometer data S(t). The SRS unit 1B in the third embodiment configured as described above can also obtain an effect the same as those in the first and second embodiments.

### Modified Example

The present invention is not limited only to the above-mentioned embodiments, additions, omissions, substitutions, and other modifications can be made without departing from the scope of the present invention. For example, in the above-mentioned embodiment, the case is exemplified that the frequency band from 5 kHz to 20 kHz (structure audio) as high-frequency vibration of the audio band and the frequency band from 0 Hz to 500 Hz as the low-frequency vibration of the audio band which is lower than the high-frequency vibration are detected, however, the frequency band in a detection target frequency is not limited to this, it may be arbitrarily set depending to a structure of the vehicle 100 and a required performance of the occupant protection. Namely, the frequency band of the high-frequency vibration may be set to capture the feature (the structure audio) where the vehicle 100 deforms (destroys) due to the frontal collision and the frequency band of the low-frequency vibration may be set to capture the deceleration generated in the vehicle 100 due to the frontal collision.

What is claimed is:

1. A collision determining apparatus for a vehicle comprising:
a vibration detection device that detects a high-frequency vibration of an audio band generated in a vehicle and a low-frequency vibration of the audio band which is lower than the high-frequency vibration; and
a collision determining device that determines whether or not a collision requiring an activation of an occupant protection apparatus of the vehicle has occurred based on the detection result of the high-frequency vibration and the low-frequency vibration.

2. The collision determining apparatus for a vehicle according to claim 1,
wherein the vibration detection device includes:
a first vibration sensor that detects a frequency band from 5 kHz to 20 kHz as the high-frequency vibration of the audio band; and
a second vibration sensor that detects a frequency band from 0 Hz to 500 Hz as the low-frequency vibration of the audio band which is lower than the high-frequency vibration.

3. The collision determining apparatus for a vehicle according to claim 2,
wherein both of the first vibration sensor and the second vibration sensor are built in a sensor cell.

4. A collision determining apparatus for a vehicle comprising:
a vibration detection device that detects a broad-band vibration generated in a vehicle;
a first extraction device that extracts a high-frequency vibration of an audio band from the broad-band vibration detected by the vibration detection device;
a second extraction device that extracts a low-frequency vibration of the audio band which is lower than the high-frequency vibration from the broad-band vibration detected by the vibration detection device; and
a collision determining device that determines whether or not a collision requiring an activation of an occupant protection apparatus of the vehicle has occurred based on the detection result of the high-frequency vibration and the low-frequency vibration.

5. The collision determining apparatus for a vehicle according to claim 4,
wherein the first extraction device extracts the frequency band from 5 kHz to 20 kHz from the broad-band vibration, as the high-frequency vibration of the audio band and the second extraction device extracts the frequency band from 0 Hz to 500 Hz from the broad-band vibration as the low-frequency vibration of the audio band which is lower than the high-frequency vibration.

6. The collision determining apparatus for a vehicle according to claim 1,
wherein the collision determining device includes:
a first calculation device that calculates a first calculation value based on the detection result of the high-frequency vibration;
a second calculation device that calculates a second calculation value based on the detection result of the low-frequency vibration; and
a map determining device that determines that a collision requiring the activation of the occupant protection apparatus has occurred, when, in a two-dimension map where a first axis is the first calculation value and a second axis is the second calculation value, the first calculation value and the second calculation value calculated by the first calculation device and the second calculation device exceed a two-dimension collision determining threshold value set in two-dimensions.

7. The collision determining apparatus for a vehicle according to claim 1,
wherein the collision determining device includes:
a first calculation device that calculates a first calculation value based on the detection result of the high-frequency vibration;
a second calculation device that calculates a second calculation value based on the detection result of the low-frequency vibration; and
a threshold value determining device that determines that a collision requiring the activation of the occupant protection apparatus has occurred when the first calculation value exceeds a first collision determining threshold value and the second calculation value exceeds a second collision determining threshold value.

8. The collision determining apparatus for a vehicle according to claim 1 further comprising:
a safing determining device that performs a safing determining based on the detection result of the low-frequency vibration; and
a final determining device that finally determines whether or not a collision requiring the activation of the occupant protection apparatus has occurred based on the collision determining result of the collision determining device and the safing determining result of the safing determining device.

9. The collision determining apparatus for a vehicle according to claim 4,
wherein the collision determining device includes:
a first calculation device that calculates a first calculation value based on the detection result of the high-frequency vibration;
a second calculation device that calculates a second calculation value based on the detection result of the low-frequency vibration; and
a map determining device that determines that a collision requiring the activation of the occupant protection apparatus has occurred, when, in a two-dimension map where a first axis is the first calculation value and a second axis is the second calculation value, the first calculation value and the second calculation value calculated by the first calculation device and the second calculation device exceed a two-dimension collision determining threshold value set in two-dimensions.

10. The collision determining apparatus for a vehicle according to claim 4,
wherein the collision determining device includes:
a first calculation device that calculates a first calculation value based on the detection result of the high-frequency vibration;
a second calculation device that calculates a second calculation value based on the detection result of the low-frequency vibration; and
a threshold value determining device that determines that a collision requiring the activation of the occupant protection apparatus has occurred when the first calculation value exceeds a first collision determining threshold value and the second calculation value exceeds a second collision determining threshold value.

11. The collision determining apparatus for a vehicle according to claim 4 further comprising:
a safing determining device that performs a safing determining based on the detection result of the low-frequency vibration; and
a final determining device that finally determines whether or not a collision requiring the activation of the occupant protection apparatus has occurred based on the collision determining result of the collision determining device and the safing determining result of the safing determining device.
